(19) United States
(12) Patent Application Publication
(10) Pub. No.: US 2016/0169168 A1
(43) Pub. Date: Jun. 16, 2016

(54) EXHAUST SYSTEM STATE DETECTION DEVICE

(71) Applicants: ISUZU MOTORS LIMITED, Tokyo (JP); TRANSTRON INC., Kanagawa (JP)

(72) Inventors: Satoshi HANAWA, Fujisawa-shi (JP); Yoshiaki IKAI, Fujisawa-shi (JP)

(73) Assignees: ISUZU MOTORS LIMITED, Tokyo (JP); TRANSTRON INC., Tokyo (JP)

(21) Appl. No.: 14/908,291

(22) PCT Filed: Jul. 31, 2014
(86) PCT No.: PCT/JP2014/070198

§ 371 Date: Jan. 28, 2016

(30) Foreign Application Priority Data
Jul. 31, 2013 (JP) 2013-159191

(51) Int. Cl. F02M 26/47; F02M 26/46; F02D 21/08; F02M 26/33

(52) U.S. Cl. CPC F02M 26/47; F02M 26/33; F02M 26/46; F02D 21/08

(57) ABSTRACT

An exhaust system state detection device includes an intake air oxygen concentration sensor that detects an oxygen concentration of an intake air of an engine, an engine revolution sensor and an accelerator position sensor that in combination detect a running condition, an indicated thermal efficiency calculation unit that calculates an amount of change in the indicated thermal efficiency of the engine based on the intake air oxygen concentration, the fuel injection start timing, and a first model formula defining the relation among the intake air oxygen concentration, the injection start timing, and the amount of change in the indicated thermal efficiency, and an exhaust gas temperature calculating unit that calculates an exhaust gas temperature based on the amount of change in the indicated thermal efficiency and a second model formula defining the relation between the exhaust gas temperature and the amount of change in the indicated thermal efficiency.

### TECHNICAL FIELD

The present invention relates to an exhaust system state detection device, and relates in particular to an exhaust system state detection device that detects a temperature of an exhaust gas emitted from an engine.

### BACKGROUND ART

Conventionally, an exhaust gas recirculation device (hereinafter referred to as “EGR device”) is known as a device for partially recirculating an exhaust gas emitted from an engine to an intake system (intake air passage). The EGR device includes an EGR cooler adapted to cool an EGR gas and other elements. The EGR cooler and other elements are disposed on a pipe that connects an exhaust system (exhaust gas passage) to the intake system.

If an oil and/or soot contained in the exhaust gas adheres in the EGR cooler, a cooling efficiency drops, and the EGR gas is recirculated at a high temperature to the intake system. In view of this problem, there is known a technique in which an exhaust gas temperature sensor is disposed on an upstream side of the EGR cooler and another exhaust gas temperature sensor is disposed on a downstream side of the EGR cooler. The cooling efficiency of the EGR cooler is diagnosed on the basis of a difference between the detected temperatures (sensor values) of these sensors (see, for example, PATENT LITERATURE DOCUMENT 1).

### LISTING OF REFERENCES

PATENT LITERATURE DOCUMENT 1: Japanese Patent Application Laid-Open Publication (Kokai) No. 2009-114871

### SUMMARY OF THE INVENTION

### Problems to be Solved by the Invention

An output of an exhaust gas temperature sensor experiences a response delay with respect to an actual temperature change of the exhaust gas. Thus, when various control processes are carried out on the basis of the exhaust gas temperature sensor, the control processes may delay to a certain extent, and therefore optimal controlling may not be performed with respect to an engine running condition.

There is another problem, i.e., when one exhaust gas temperature sensor is disposed on the upstream side of the EGR cooler and another exhaust gas temperature sensor is disposed on the downstream side of the EGR cooler, a cost of the entire device increases due to the increasing number of sensors.

An object of the present invention is to provide an exhaust system state detection device that has a simple configuration and can effectively detect a temperature of an exhaust gas.

### Solution to Overcome the Problems

An exhaust system state detection device disclosed herein includes an oxygen concentration detecting unit that detects an oxygen concentration in an intake air of an engine, a running condition detecting unit that detects a running condition of the engine, an indicated thermal efficiency change calculating unit that calculates an amount of change in an indicated thermal efficiency of the engine on the basis of the detected intake air oxygen concentration, a fuel injection start timing set in accordance with the detected running condition, and a first model formula that is stored in advance and defines a relation among at least the intake air oxygen concentration, the fuel injection start timing and the amount of change in the indicated thermal efficiency, and an exhaust gas temperature calculating unit that calculates the exhaust gas temperature of the engine on the basis of the calculated amount of change in the indicated thermal efficiency and a second model formula that is stored in advance and defines a relation between at least the exhaust gas temperature and the amount of change in the indicated thermal efficiency.

### Advantages of the Invention

According to an exhaust system state detection device disclosed herein, the device has a simple configuration and can effectively detect an exhaust gas temperature.

### BRIEF DESCRIPTION OF THE DRAWINGS

FIG. 1 is an overall configuration diagram schematically illustrating an exhaust system state detection device according to an embodiment of the present invention.

FIG. 2 is a flowchart illustrating the control performed by the exhaust system state detection device according to the embodiment of the present invention.

### MODE FOR CARRYING OUT THE INVENTION

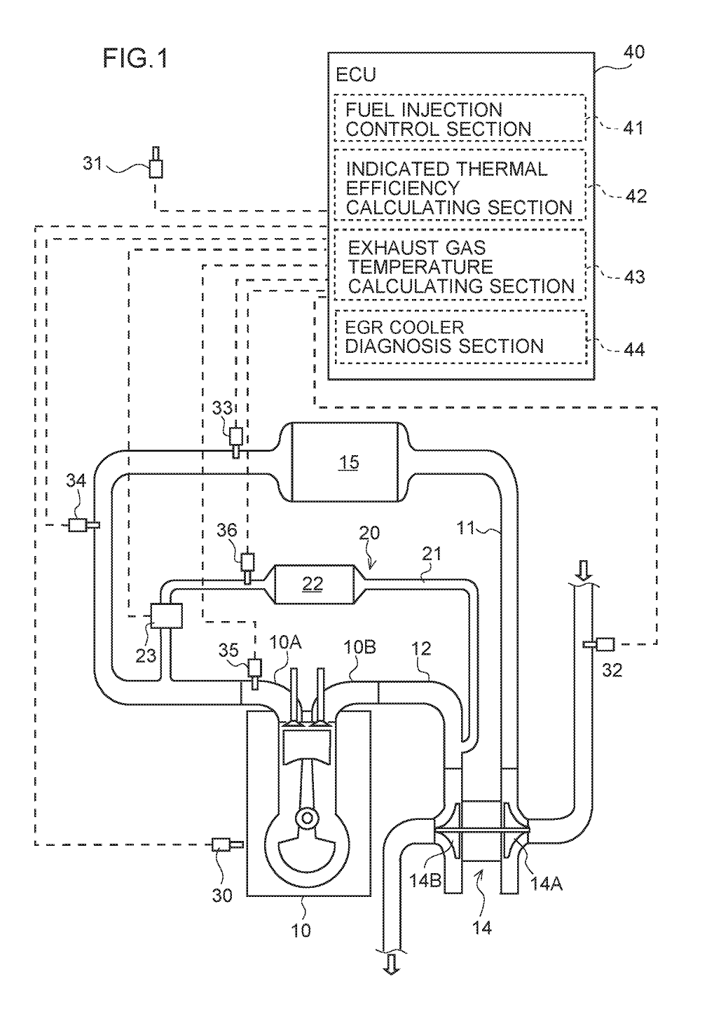

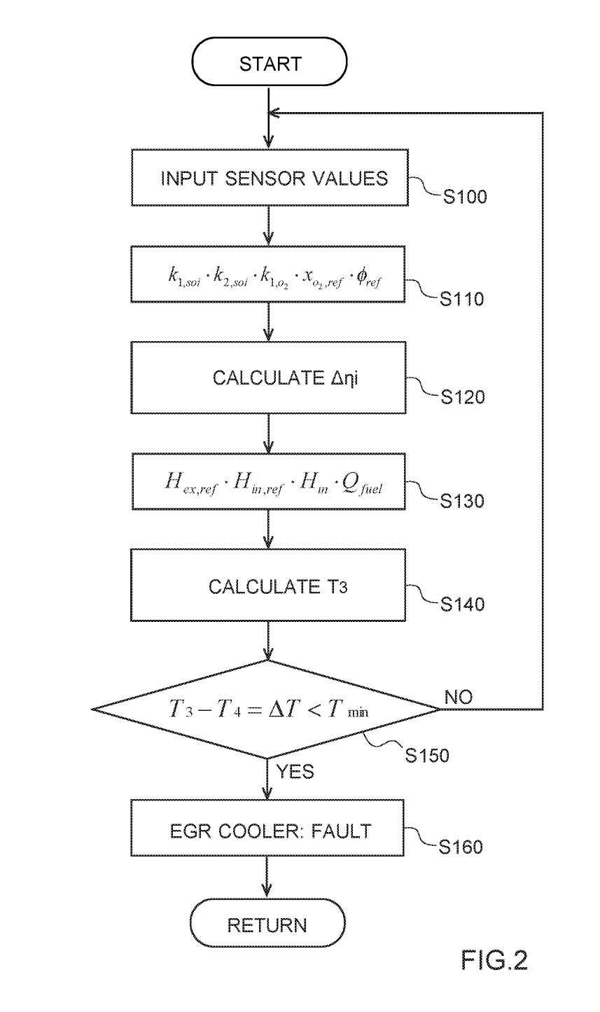

Hereinafter, an exhaust system state detection device according to an embodiment of the present invention will be described with reference to FIGS. 1 and 2. Identical parts are given identical reference numerals and symbols, and their names and functions are identical as well. Therefore, detailed description of such parts will not be repeated.

As illustrated in FIG. 1, a diesel engine (hereinafter simply referred to as “engine”) 10 has an intake manifold 10A and an exhaust manifold 10B. The intake manifold 10A is connected to an intake passage (intake pipe) 11 for introducing fresh air, and the exhaust manifold 10B is connected to an exhaust passage (exhaust pipe) 12 for discharging an exhaust gas to the atmosphere.

The exhaust passage 12 has a turbine 14B of a turbo charger 14, and an exhaust gas aftertreatment device (not illustrated). The turbine 14B is disposed upstream of the exhaust gas aftertreatment device. The intake passage 11 has an MAF sensor 32, a compressor 14A of the turbo charger 14, an intercooler 15, an intake air temperature sensor 33, an intake air oxygen concentration sensor (oxygen concentration detecting unit) 34, and a boost pressure sensor 35. The MAF sensor 32, the compressor 14A of the turbo charger, the intercooler 15, the intake air temperature sensor 33, the intake air oxygen concentration sensor 34, and the boost pressure sensor 35 are arranged in this order from the upstream side. Sensor values detected by the sensors 32 to 35 are supplied to an electronic control unit (hereinafter referred to as “ECU”) 40, which is electrically connected the sensors 32 to 35.

An EGR device 20 includes an EGR passage 21 for recirculating some of the exhaust gas into the intake system, an EGR cooler (recirculated exhaust gas cooling unit) 22 for cooling an EGR gas, and an EGR valve 23 for regulating the flow rate of the EGR gas. An EGR cooler outlet temperature sensor (exhaust gas temperature detecting unit) 36 for detecting the temperature of the EGR gas cooled by the EGR cooler 22 is provided in the EGR passage 21 on the downstream (outlet) side of the EGR cooler 22. The sensor value detected by the EGR cooler outlet temperature sensor 36 is supplied to the ECU 40, which is electrically connected to the sensor 36.

An engine rotation speed sensor 30 detects the number of rotations of a crankshaft (not illustrated) per unit time. An accelerator position sensor 31 detects the accelerator position corresponding to a depressed amount of an accelerator pedal (not illustrated). The sensor values detected by the sensors 30 and 31 are supplied to the ECU 40, which is electrically connected to the sensors 30 and 31. It should be noted that the engine rotation speed sensor 30 and the accelerator position sensor 31 are preferred examples of the running condition detecting unit.

The ECU 40 controls fuel injection and other functions of the engine 10, and includes publicly known CPU, ROM, RAM, input port, output port, and other elements and devices. The ECU 40 further includes, as some of its functional elements, a fuel injection control section 41, an indicated thermal efficiency calculating section (indicated thermal efficiency change calculating unit) 42, an exhaust gas temperature calculating section (exhaust gas temperature calculating unit) 43, and an EGR cooler diagnosis section (diagnosing unit) 44. The description continues with a premise that these functional elements are included in the ECU 40, which is an integrated piece of hardware, but some of these functional elements may be provided in a separate piece of hardware.

The fuel injection control section 41 controls the fuel injection timing and the fuel injection amount of a fuel injection device (not illustrated) of the engine 10 on the basis of the engine revolution speed N entered from the engine rotation speed sensor 30 and the accelerator position Q entered from the accelerator position sensor 31.

The indicated thermal efficiency calculating section 42 calculates an amount of change Δηᵢ in the indicated thermal efficiency of the engine 10 on the basis of the sensor values detected by the sensors 30 to 36, model formulas (will be described later), and so on. The calculation procedures will now be described in detail.

The conservation of energy in cylinders of the engine 10 is expressed by the following expression (1), which indicates a relation among exhaust gas energy Hₑₓ, intake air energy Hᵢₙ, fuel combustion energy Q_{fuel}, cooling loss energy Uₕₗₒₛₛ, and indicated work W_{id} of the engine 10.

Hₑₓ=Hᵢₙ+Q_{fuel}−Uₕₗₒₛₛ−W_{id} [Math. 1]

The indicated thermal efficiency ηᵢ of the engine 10 is expressed by the following expression (2), which indicates the ratio of the indicated work W_{id} to the combustion energy Q_{fuel}.

ηᵢ≡W_{id}/Q_{fuel} [Math. 2]

When the indicated work W_{id} of the expression (2) is substituted into the expression (1), the exhaust gas energy Hₑₓ is expressed by the following expression (3).

Hₑₓ=(1−ηᵢ)Q_{fuel}−Uₕₗₒₛₛ+Hᵢₙ [Math. 3]

An amount of change ΔHₑₓ from the reference exhaust gas energy H_{ex,ref} is calculated on the basis of the expression (3), and the result is expressed by the following expression (4).

$$\begin{matrix}Δ {H}_{ex} = {H}_{ex} - {H}_{ex , ref} \\ = [ ( 1 - {η}_{i} ) {Q}_{fuel} - {U}_{hloss} + {H}_{i n} ] - \\ [ ( 1 - {η}_{i , ref} ) {Q}_{fuel , ref} - {U}_{hloss , ref} + {H}_{i n , ref} ]\end{matrix} \qquad [ Math . 4 ]$$

Provided that the fuel injection amount is constant and the change in the cooling loss energy Uₕₗₒₛₛ is very small in the expression (4), the amount of change ΔHₑₓ in the exhaust gas energy is approximated by the following expression (5).

ΔHₑₓ≈Hᵢₙ−H_{in,ref}−Δηᵢ·Q_{fuel} [Math. 5]

A temperature of the exhaust gas discharged from the engine 10 (hereinafter referred to as “engine outlet exhaust gas temperature”) T₃ is expressed by the following expression (6) on the basis of ΔHₑₓ=Hₑₓ−H_{ex,ref} of the expression (4).

$${T}_{3} = \frac{1}{{c}_{p , ex} \cdot {m}_{ex}} ( {H}_{ex , ref} + Δ {H}_{ex} ) , \\ where \\ {H}_{ex} = {c}_{p , ex} {T}_{3} {m}_{ex} \qquad [ Math . 6 ]$$

When the expression (5) is substituted into the expression (6), the engine outlet exhaust gas temperature T₃ is expressed by the following expression (7) (second model formula), where C_{p.in} represents specific heat at constant pressure of the intake air, mₑₓ represents the exhaust gas flow rate, H_{ex,ref} represents the reference exhaust gas energy, H_{in,ref} represents reference intake air energy, Hᵢₙ represents the exhaust gas energy, and Q_{fuel} represents the combustion energy.

$${T}_{3} = \frac{1}{{c}_{p , ex} \cdot {m}_{ex}} ( {H}_{ex , ref} + {H}_{i n} - {H}_{i n , ref} - Δ {η}_{i} \cdot {Q}_{fuel} ) \qquad [ Math . 7 ]$$

As the factors that may cause a change in the indicated thermal efficiency ηᵢ, a fuel injection start timing φ and an intake air oxygen concentration X_{O2} will now be considered. Provided that the change in the amount of change Δηᵢ in the indicated thermal efficiency with respect to the intake air oxygen concentration X_{O2} is linear, the amount of change Δηᵢ in the indicated thermal efficiency is approximated by a Taylor expansion as in the following expression (8), where X_{O2} represents an intake air oxygen concentration, φ represents the injection start timing, K_{1,O2} represents the intake air oxygen concentration correction coefficient, X_{O2,ref} represents a reference intake air oxygen concentration, k_{n(n=1,2),soi} represents an injection start timing correction coefficient, and φ_{ref} represents a reference injection start timing.

$$\begin{matrix}Δ {η}_{i} = {η}_{i} - {η}_{i , ref} \\ \approx {k}_{1 , soi} \cdot ( φ - {φ}_{ref} ) + {k}_{1 , {o}_{2}} \cdot ( {x}_{{o}_{2}} - {x}_{{o}_{2} , ref} ) + \\ {k}_{2 , soi} \cdot {( φ - {φ}_{ref} )}^{2} + {k}_{2 , soi \cdot o 2} \cdot ( φ - {φ}_{ref} ) \cdot \\ ( {x}_{{o}_{2}} - {x}_{{o}_{2} , ref} )\end{matrix} \qquad [ Math . 8 ]$$

Provided that an influence of the interaction term between the injection start timing φ and the intake air oxygen concentration X_{O2} is very small in the expression (8), the amount of change Δηᵢ in the indicated thermal efficiency is expressed by the following expression (9) (first model formula).

Δηᵢ=k_{1,soi}·(φ−φ_{ref})+k_{1,o}_{₂}·(xₒ_{₂}−xₒ_{₂}_{,ref})+k_{2,soi}·(φ−φ_{ref})² [Math. 9]

The indicated thermal efficiency calculating section 42 calculates the amount of change Δηᵢ in the indicated thermal efficiency in real time on the basis of the expression (9). More specifically, the ECU 40 stores a correction value map (not illustrated) that defines a relation among the engine revolution speed N, the accelerator position Q, and the intake air oxygen concentration correction coefficient K_{1,O2}, and also stores a reference value map (not illustrated) that defines a relation among the engine revolution speed N, the accelerator position Q, and the reference intake air oxygen concentration X_{O2,ref}. These maps are prepared in advance through experiments or the like. The ECU 40 further stores another correction value map (not illustrated) that defines a relation among the engine revolution speed N, the accelerator position Q, and the injection start timing correction coefficient k_{n(n=1,2),soi}, and another reference value map (not illustrated) that defines a relation among the engine revolution speed N, the accelerator position Q, and the reference injection start timing φ_{ref}. These maps are also prepared in advance through experiments or the like.

The indicated thermal efficiency calculating section 42 reads the values corresponding to the running condition of the engine 10 from the maps and substitutes the values into the expression (9). In addition, the indicated thermal efficiency calculating section 42 substitutes into the expression (9) the intake air oxygen concentration X_{O2}, which is entered from the intake air oxygen concentration sensor 34, and the injection start timing φ, which is determined by the fuel injection control section 41. Thus, the amount of change Δηᵢ in the indicated thermal efficiency that reflects the amount of change from the reference intake air oxygen concentration X_{O2,ref} and the amount of change from the reference injection start timing φ_{ref} is calculated in real time in accordance with the running condition of the engine 10.

The exhaust gas temperature calculating section 43 calculates the engine outlet exhaust gas temperature T₃ in real time on the basis of the expression (7). More specifically, the ECU 40 stores a reference value map (not illustrated) that specifies a relation among the engine revolution speed N, the accelerator position Q, and the reference intake air energy H_{in,ref}, and also stores another reference value map (not illustrated) that specifies a relation among the engine revolution speed N, the accelerator position Q, and the reference exhaust gas energy H_{ex,ref}. These maps are prepared in advance through experiments or the like.

The exhaust gas temperature calculating section 43 reads the values corresponding to the running condition of the engine 10 from these maps, and calculates the intake air energy Hᵢₙ by the following expression (10), which indicates a relation among the specific heat at constant pressure of the intake air C_{p,in}, an intake air temperature T₂, and an intake air flow rate mᵢₙ.

Hᵢₙ=c_{p,in}·T₂·mᵢₙ [Math. 10]

The exhaust gas temperature calculating section 43 further calculates the fuel combustion energy Q_{fuel} by the following expression (11), which indicates a relation between a lower heating value hₗ of the fuel and a fuel injection amount m_{fuel}.

Q_{fuel}=hₗ·m_{fuel} [Math. 11]

The exhaust gas temperature calculating section 43 then calculates the engine outlet exhaust gas temperature T₃ by substituting into the expression (7) the values read from the maps, the values calculated by the expressions (10) and (11), the specific heat at constant pressure of the exhaust gas C_{p,ex}, and the exhaust gas flow rate mₑₓ. Thus, the engine outlet exhaust gas temperature T₃, which varies with the running condition of the engine 10, is calculated in real time. It should be noted that the exhaust gas flow rate mₑₓ may be directly detected by an exhaust gas flow rate sensor (not illustrated). Alternatively, the exhaust gas flow rate mₑₓ may be estimated on the basis of the running condition of the engine 10, which is derived from the engine revolution speed N and the accelerator position Q.

The EGR cooler diagnosis section 44 carries out a fault diagnosis of the EGR cooler 22 on the basis of the engine outlet exhaust gas temperature T₃, which is calculated by the exhaust gas temperature calculating section 43, and the EGR cooler out let temperature T₄, which is entered from the ERG cooler outlet temperature sensor 36.

More specifically, the ECU 40 stores a lower threshold value Tₘᵢₙ, which is obtained (prepared) in advance through experiments or the like. The lower threshold value Tₘᵢₙ indicates a fault in the EGR cooler 22. The “fault” used herein includes, for example, a state in which the soot and/or an oil contained in the exhaust gas adheres onto a fin (not illustrated) and other parts of the ERG cooler 22, and heat exchange between the EGR gas and the cooling water is hindered such that the cooling efficiency significantly drops.

The EGR cooling diagnosis section 44 determines that a fault has occurred in the EGR cooler 22 when the temperature difference ΔT between the engine outlet exhaust gas temperature T₃ and the EGR cooler outlet temperature T₄ becomes lower (smaller) than the lower threshold value Tₘᵢₙ. It should be noted that this determination of a fault does not have to be based on the temperature difference ΔT, and may be made on the basis of the ratio T₃/T₄ of the engine outlet exhaust gas temperature T₃ to the EGR cooler outlet temperature T₄.

Referring now to FIG. 2, a control process of the exhaust system state detection device according to this embodiment will be described.

In Step 100, the sensor values of the sensors 30 to 36 are supplied to the ECU 40 upon turning on of the ignition key.

In Step 110, in accordance with the running condition of the engine 10, the intake air oxygen concentration correction coefficient k_{1,O2} and the injection start timing correction coefficient k_{n(n=1,2),soi} are read from the correction value maps, and the reference intake air oxygen concentration X_{O2,ref} and the reference injection start timing φ_{ref} are read from the reference value maps.

In Step 120, the amount of change Δηᵢ in the indicated thermal efficiency is calculated through the model formula of the expression (9) on the basis of the values read from the respective maps in Step 110, the intake air oxygen concentration X_{O2} entered from the intake air oxygen concentration sensor 34, and the injection start timing φ determined by the fuel injection control section 41.

In Step 130, in accordance with the running condition of the engine 10, the reference intake air energy H_{in,ref} and the reference exhaust gas energy H_{ex,ref} are read from the reference value maps, and the exhaust gas energy Hᵢₙ and the combustion energy Q_{fuel} are calculated by the expressions (10) and (11).

In Step 140, the engine outlet exhaust gas temperature T₃ is calculated through the model formula of the expression (7) on the basis of the amount of change Δηᵢ in the indicated thermal efficiency calculated in Step 120, the values read from the maps in Step 130, and the values calculated by the expressions (10) and (11).

In Step 150, a fault diagnosis is made on the EGR cooler 22 on the basis of the temperature difference ΔT between the engine output exhaust gas temperature T₃ calculated in Step 140 and the EGR cooler outlet temperature T₄ entered from the EGR cooler outlet temperature sensor 36. When the temperature difference ΔT is lower than the lower threshold value Tₘᵢₙ (YES), it is determined in Step 160 that a fault has occurred in the EGR cooler 22. On the other hand, when the temperature difference ΔT is no smaller than the lower threshold value Tₘᵢₙ (NO), the control is returned to Step 100. Thereafter, Steps 100 to 160 are iterated until the ignition key is turned off.

Effects and advantages provided by the exhaust system state detection device according to this embodiment will now be described.

Conventionally, the temperature of the exhaust gas emitted from the engine is directly measured by the exhaust gas temperature sensor disposed on the exhaust passage. Because a response delay from an actual exhaust gas temperature arises in the sensor output value of the exhaust gas temperature sensor, there is a problem, i.e., various control processing to the engine may delay.

In contrast, the exhaust system state detection device according to this embodiment calculates the amount of change Δηᵢ in the indicated thermal efficiency of the engine 10 in real time with the model formula of the expression (9), and also calculates the engine outlet exhaust gas temperature T₃ in real time with the amount of change Δηᵢ in the indicated thermal efficiency and the model formula of the expression (7). In other words, the exhaust system state detection device does not use the exhaust gas temperature sensor, which generates a response delay, but does use the pre-defined model formula to calculate the engine outlet exhaust gas temperature T₃ quickly and precisely.

Therefore, the exhaust system state detection device of this embodiment can have a simple configuration that uses the model formula, and effectively detect (calculate) the engine outlet exhaust gas temperature T₃.

Conventionally, an exhaust gas temperature sensor is disposed upstream of the ERG cooler and another exhaust gas temperature sensor is disposed downstream of the ERG cooler in order to diagnose the ERG cooler. Thus, there are problems, i.e., the diagnosis is influenced by the response delays of the exhaust gas temperature sensors, and the cost of the entire device is increased by the increased number of the sensors.

In contrast, the exhaust system state detection device of this embodiment is configured to determine the fault of the EGR cooler 22 on the basis of the temperature difference ΔT between the engine outlet exhaust gas temperature T₃, which is calculated in real time by the model formula of the expression (7), and the ERG cooler outlet temperature T₄, which is entered from the ERG cooler outlet temperature sensor 36.

Therefore, the exhaust system state detection device of this embodiment is not influenced by the sensor response delay, and can diagnose the ERG cooler 22 quickly and accurately. Also, because the upstream exhaust gas temperature sensor can be dispensed with, the cost increase related to the number of sensors can effectively be suppressed.

It should be noted that the present invention is not limited to the above-described embodiment and can be implemented with modifications, as appropriate, within the scope that does not depart from the spirit of the present invention.

For example, although the engine outlet exhaust gas temperature T₃, which is calculated by the exhaust gas temperature calculating section 43, is used in the diagnosis of the EGR cooler 22 in the above-described embodiment, the engine outlet exhaust gas temperature T₃ may be used in the control applied to an amount of EGR gas and/or an exhaust gas aftertreatment device (not illustrated). It should also be noted that the engine 10 is not limited to a diesel engine. The present invention can be applied widely to other engines including a gasoline engine. In any of such cases, the same effects and advantages as the above-described embodiments are obtained.

### REFERENCE NUMERALS AND SYMBOLS

10: Engine
20: EGR device
22: EGR cooler (recirculated exhaust gas cooling unit)
30: Engine revolution sensor (running condition detecting unit)
31: Accelerator position sensor (running condition detecting unit)
34: Intake air oxygen concentration sensor (oxygen concentration detecting unit)
35: Boost pressure sensor
36: EGR cooler outlet temperature sensor (exhaust gas temperature detecting unit)
40: ECU
42: Indicated thermal efficiency calculating section (indicated thermal efficiency change calculating unit)
43: Exhaust gas temperature calculating section (exhaust gas temperature calculating unit)
44: EGR cooler diagnosis section (diagnosing unit)

1. An exhaust system state detection device comprising:
an oxygen concentration detecting unit that detects an oxygen concentration in an intake air of an engine;
a running condition detecting unit that detects a running condition of the engine;
an indicated thermal efficiency change calculating unit that calculates an amount of change in an indicated thermal efficiency of the engine based on the detected intake air oxygen concentration, a fuel injection start timing set in accordance with the detected running condition, and a first model formula that is stored in advance and defines a relation among at least the intake air oxygen concentration, the fuel injection start timing and the amount of change in the indicated thermal efficiency; and
an exhaust gas temperature calculating unit that calculates a first exhaust gas temperature of the engine based on the calculated amount of change in the indicated thermal efficiency and a second model formula that is stored in advance and defines a relation between at least the first exhaust gas temperature and the amount of change in the indicated thermal efficiency.

2. The exhaust system state detection device according to claim 1, further comprising:
a recirculated exhaust gas cooling unit that cools a recirculated exhaust gas, the recirculated exhaust gas cooling unit being disposed on a recirculated exhaust gas passage, which connects an intake system of the engine to an exhaust system of the engine;
an exhaust gas temperature detecting unit that is disposed on the recirculated exhaust gas passage downstream of the recirculated exhaust gas cooling unit, the exhaust gas temperature detecting unit being configured to detect a second exhaust gas temperature; and
a diagnosing unit that diagnoses a cooling efficiency of the recirculated exhaust gas cooling unit based on the first exhaust gas temperature calculated by the exhaust gas temperature calculating unit and the second exhaust gas temperature detected by the exhaust gas temperature detecting unit.

3. The exhaust system state detection device according to claim 1, wherein the first model formula includes a reference intake air oxygen concentration set in accordance with the running condition, an intake air oxygen concentration correction coefficient set in accordance with the running condition, a reference fuel injection start timing set in accordance with the running condition, and a fuel injection start timing correction coefficient set in accordance with the running condition.

4. The exhaust system state detection device according to claim 1, wherein the second model formula includes a reference exhaust gas energy set in accordance with the running condition, a reference intake air energy set in accordance with the running condition, an intake air energy calculated from at least an amount of intake air and a temperature of the intake air, and a combustion energy calculated from an amount of fuel injection set in accordance with the running condition.

5. The exhaust system state detection device according to claim 2, wherein the first model formula includes a reference intake air oxygen concentration set in accordance with the running condition, an intake air oxygen concentration correction coefficient set in accordance with the running condition, a reference fuel injection start timing set in accordance with the running condition, and a fuel injection start timing correction coefficient set in accordance with the running condition.

6. The exhaust system state detection device according to claim 2, wherein the second model formula includes a reference exhaust gas energy set in accordance with the running condition, a reference intake air energy set in accordance with the running condition, an intake air energy calculated from at least an amount of intake air and a temperature of the intake air, and a combustion energy calculated from an amount of fuel injection set in accordance with the running condition.

7. The exhaust system state detection device according to claim 3, wherein the second model formula includes a reference exhaust gas energy set in accordance with the running condition, a reference intake air energy set in accordance with the running condition, an intake air energy calculated from at least an amount of intake air and a temperature of the intake air, and a combustion energy calculated from an amount of fuel injection set in accordance with the running condition.

8. The exhaust system state detection device according to claim 1, wherein the running condition of the engine includes an engine revolution speed and an accelerator position.

9. The exhaust system state detection device according to claim 1, wherein the exhaust gas temperature calculating unit calculates the first exhaust gas temperature in real time.

10. The exhaust system state detection device according to claim 2, wherein when a difference between the first exhaust gas temperature and the second exhaust gas temperature is smaller than a threshold value, the diagnosing unit determines that a fault has occurred in the recirculated exhaust gas cooling unit.

11. The exhaust system state detection device according to claim 2, wherein when a ratio of the first exhaust gas temperature to the second exhaust gas temperature is smaller than a predetermined value, the diagnosing unit determines that a fault has occurred in the recirculated exhaust gas cooling unit.

12. The exhaust system state detection device according to claim 1, wherein the exhaust gas temperature calculating unit does not use a temperature sensor when calculating the first exhaust gas temperature.

13. The exhaust system state detection device according to claim 1, wherein the engine is a diesel engine.
